(19) United States
(12) Patent Application Publication
(10) Pub. No.: US 2025/0179648 A1
(43) Pub. Date: Jun. 5, 2025

(54) UNDER-DEPOSIT CORROSION INHIBITORS AND METHODS OF USING THE SAME

(71) Applicant: ChampionX LLC, Sugar Land, TX (US)

(72) Inventors: Sherman Kin Yee KUNG, Calgary (CA); Nolan MILLER, Calgary (CA); Feras Mohamed S. EL YAAKOBI, Chestermere (CA); Jeremy MOLONEY, Katy, TX (US)

(73) Assignee: ChampionX LLC, Sugar Land, TX (US)

(21) Appl. No.: 18/953,751

(22) Filed: Nov. 20, 2024

Related U.S. Application Data
(60) Provisional application No. 63/604,512, filed on Nov. 30, 2023.

(51) Int. Cl. C23F 11/12; C23F 11/14

(52) U.S. Cl. CPC C23F 11/124; C23F 11/141

(57) ABSTRACT

The present disclosure provides compositions and methods of inhibiting corrosion, including under-deposit corrosion, of a metal surface in contact with a medium. A method may include adding a composition to the metal surface. A composition may include a first reaction product, a second reaction product, a trimer acid, a solvent, and a viscosifier dimer acid. The first reaction product may be produced by reacting a first amine with a first carboxylic acid and a dimer acid. The second reaction product may be produced by reacting a second amine with a second carboxylic acid.

### TECHNICAL FIELD

The present disclosure generally relates to compositions and methods for inhibiting corrosion. More particularly, the disclosure relates to compositions comprising a viscosifier dimer acid and methods of using the compositions for inhibiting under-deposit corrosion.

### BACKGROUND

Aqueous liquids are injected into the earth and/or recovered from the earth during subterranean hydrocarbon recovery processes. In some processes, an aqueous fluid is injected into a subterranean formation and a water source is recovered, i.e., flows back from the subterranean formation and is collected along with a hydrocarbon product. The injectate and the produced water may include one or more corrodents, such as salts and/or other dissolved solids, liquids, and/or gases that cause, accelerate, or promote corrosion of metal surfaces and/or containments, such as metal pipelines and metal tanks.

Corrosion inhibitors are typically employed to reduce corrosion of metal surfaces that are contacted by liquids containing corrodents. For example, corrosion inhibitors can protect carbon steel pipelines and infrastructures from corrosion in oil and gas industries. Corrosion inhibitors may be added to the liquids and dissolved gasses that come into contact with the metal surfaces and they act to prevent, retard, delay, reverse, and/or otherwise inhibit corrosion of the metal surfaces.

Under-deposit corrosion (UDC) is one of the most aggressive forms of corrosion in the oil and gas industry and commonly results in severe localized corrosion. Most published work addressing UDC has focused on sand, iron sulfide or elemental sulfur independently. Corrosion inhibitors have been shown to effectively mitigate UDC where a single type of solid is present. However, there is a need for corrosion inhibitors that can handle UDC when different types of solids are present.

### BRIEF SUMMARY

The present disclosure provides methods and compositions for inhibiting corrosion of a metal surface.

In some embodiments, a method of inhibiting corrosion of a metal surface in contact with a medium may comprise adding a composition to the metal surface, wherein the composition comprises a first reaction product, a second reaction product, a trimer acid, a solvent, and a viscosifier dimer acid, wherein the first reaction product is produced by reacting a first amine with a first carboxylic acid and a dimer acid, and the second reaction product is produced by reacting a second amine with a second carboxylic acid.

In some embodiments, a composition of the present disclosure comprises a first reaction product, a second reaction product, a trimer acid, a solvent, and a viscosifier dimer acid, wherein the first reaction product is produced by reacting a first amine with a first carboxylic acid and a dimer acid, and the second reaction product is produced by reacting a second amine with a second carboxylic acid.

The foregoing has outlined rather broadly the features and technical advantages of the present disclosure in order that the detailed description that follows may be better understood. Additional features and advantages of the disclosure will be described hereinafter that form the subject of the claims of this application.

### DETAILED DESCRIPTION

Various embodiments are described below. The relationship and functioning of the various elements of the embodiments will be better understood in light of the following detailed description. However, elements and embodiments are not strictly limited to those explicitly described below.

Examples of methods and materials are described below, although methods and materials similar or equivalent to those described herein can be used in practice or testing of the present disclosure. All publications, patent applications, patents and other reference materials mentioned herein are incorporated by reference in their entirety. The materials, methods, and examples disclosed herein are illustrative only and not intended to be limiting.

Unless otherwise defined, all technical and scientific terms used herein have the same meaning as commonly understood by one of ordinary skill in the art. In case of conflict, the present document, including definitions, will control.

Unless otherwise indicated, an alkyl group as described herein alone or as part of another group is an optionally substituted linear or branched saturated monovalent hydrocarbon substituent containing from, for example, one to about sixty carbon atoms, such as one to about thirty carbon atoms, in the main chain. Examples of unsubstituted alkyl groups include methyl, ethyl, n-propyl, i-propyl, n-butyl, i-butyl, s-butyl, t-butyl, n-pentyl, i-pentyl, s-pentyl, t-pentyl, and the like.

The terms “aryl” or “ar” as used herein alone or as part of another group (e.g., arylene) denote optionally substituted homocyclic aromatic groups, such as monocyclic or bicyclic groups containing from about 6 to about 12 carbons in the ring portion, such as phenyl, biphenyl, naphthyl, substituted phenyl, substituted biphenyl or substituted naphthyl. The term “aryl” also includes heteroaryl functional groups. It is understood that the term “aryl” applies to cyclic substituents that are planar and comprise 4n+2 electrons, according to Huckel's Rule.

“Cycloalkyl” refers to a cyclic alkyl substituent containing from, for example, about 3 to about 8 carbon atoms, preferably from about 4 to about 7 carbon atoms, and more preferably from about 4 to about 6 carbon atoms. Examples of such substituents include cyclopropyl, cyclobutyl, cyclopentyl, cyclohexyl, cycloheptyl, cyclooctyl, and the like. The cyclic alkyl groups may be unsubstituted or further substituted with alkyl groups, such as methyl groups, ethyl groups, and the like.

“Heteroaryl” refers to a monocyclic or bicyclic 5- or 6-membered ring system, wherein the heteroaryl group is unsaturated and satisfies Huckel's rule. Non-limiting examples of heteroaryl groups include furanyl, thiophenyl, pyrrolyl, pyrazolyl, imidazolyl, 1,2,3-triazolyl, 1,2,4-triazolyl, isoxazolyl, oxazolyl, isothiazolyl, thiazolyl, 1,3,4-oxadiazol-2-yl, 1,2,4-oxadiazol-2-yl, 5-methyl-1,3,4-oxadiazole, 3-methyl-1,2,4-oxadiazole, pyridinyl, pyrimidinyl, pyrazinyl, triazinyl, benzofuranyl, benzothiophenyl, indolyl, quinolinyl, isoquinolinyl, benzimidazolyl, benzoxazolinyl, benzothiazolinyl, quinazolinyl, and the like.

Compounds of the present disclosure may be substituted with suitable substituents. The term “suitable substituent,” as used herein, is intended to mean a chemically acceptable functional group, preferably a moiety that does not negate the activity of the compounds. Such suitable substituents include, but are not limited to, halo groups, perfluoroalkyl groups, perfluoro-alkoxy groups, alkyl groups, alkenyl groups, alkynyl groups, hydroxy groups, oxo groups, mercapto groups, alkylthio groups, alkoxy groups, aryl or heteroaryl groups, aryloxy or heteroaryloxy groups, aralkyl or heteroaralkyl groups, aralkoxy or heteroaralkoxy groups, HO—(C═O)— groups, heterocylic groups, cycloalkyl groups, amino groups, alkyl- and dialkylamino groups, carbamoyl groups, alkylcarbonyl groups, alkoxycarbonyl groups, alkylaminocarbonyl groups, dialkylamino carbonyl groups, arylcarbonyl groups, aryloxy-carbonyl groups, alkylsulfonyl groups, and arylsulfonyl groups. In some embodiments, suitable substituents may include halogen, an unsubstituted C₁-C₁₂ alkyl group, an unsubstituted C₄-C₆ aryl group, or an unsubstituted C₁-C₁₀ alkoxy group. Those skilled in the art will appreciate that many substituents can be substituted by additional substituents.

The term “substituted” as in “substituted alkyl,” means that in the group in question (e.g., the alkyl group), at least one hydrogen atom bound to a carbon atom is replaced with one or more substituent groups, such as hydroxy (—OH), alkylthio, phosphino, amido (—CON(R_{A})(R_{B}), wherein R_{A} and R_{B} are independently hydrogen, alkyl, or aryl), amino (—N(R_{A})(R_{B}), wherein R_{A} and R_{B} are independently hydrogen, alkyl, or aryl), halo(fluoro, chloro, bromo, or iodo), silyl, nitro (—NO₂), an ether (—OR_{A} wherein R_{A} is alkyl or aryl), an ester (—OC(O)R_{A} wherein R_{A} is alkyl or aryl), keto (—C(O)R_{A} wherein R_{A} is alkyl or aryl), heterocyclo, and the like.

When the term “substituted” introduces a list of possible substituted groups, it is intended that the term apply to every member of that group. That is, the phrase “optionally substituted alkyl or aryl” is to be interpreted as “optionally substituted alkyl or optionally substituted aryl.”

The terms “polymer,” “copolymer,” “polymerize,” “copolymerize,” and the like include not only polymers comprising two monomer residues and polymerization of two different monomers together, but also include (co) polymers comprising more than two monomer residues and polymerizing together more than two or more other monomers. For example, a polymer as disclosed herein includes a terpolymer, a tetrapolymer, polymers comprising more than four different monomers, as well as polymers comprising, consisting of, or consisting essentially of two different monomer residues. Additionally, a “polymer” as disclosed herein may also include a homopolymer, which is a polymer comprising a single type of monomer unit.

Unless specified differently, the polymers of the present disclosure may be linear, branched, crosslinked, structured, synthetic, semi-synthetic, natural, and/or functionally modified. A polymer of the present disclosure can be in the form of a solution, a dry powder, a liquid, or a dispersion, for example.

The present disclosure relates to corrosion inhibitor compositions and methods of using the same to inhibit corrosion. The compositions and methods can mitigate corrosion in the presence of, for example, elemental sulfur, polysulfide, and/or iron sulfide with little or no localized corrosion observed. The compositions are also capable of withstanding an extremely corrosive under-deposit environment.

A composition of the present disclosure may include various components, such as a first reaction product, a second reaction product, a trimer acid, a solvent, and a viscosifier dimer acid.

The first reaction product may be produced by reacting a first amine with a first carboxylic acid and a dimer acid. In some embodiments, the first reaction product comprises a cyclic amine, such as an imidazoline or pyridine.

The imidazoline compound may have, for example, formula (I), (II), or (III):

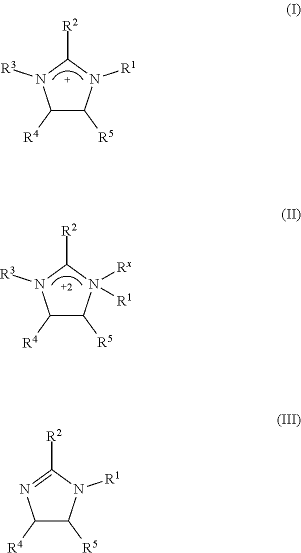

wherein R¹, R⁴, and R⁵ are each independently selected from hydrogen, alkyl, alkenyl, alkynyl, cycloalkyl, cycloalkenyl, aryl, heteroaryl, and heterocycle, said alkyl, alkenyl, alkynyl, cycloalkyl, cycloalkenyl, aryl, heteroaryl, and heterocycle each independently, at each occurrence, unsubstituted or substituted with 1 to 3 substituents independently selected from halogen, —COR⁶, —CO₂R⁷, —SO₃R⁸, —PO₃H₂, —CON(R⁹)(R¹⁰), —OR¹¹, and —N(R¹²)(R¹³); R² is a radical derived from a fatty acid; R³ and R^{x} are each independently selected from a radical derived from an unsaturated acid;

R⁶, R⁷, R⁸, R⁹, R¹⁰, and R¹¹ are each independently, at each occurrence, selected from hydrogen, alkyl, and alkenyl; R¹² and R₁₃ are each independently, at each occurrence, selected from hydrogen, alkyl, —COR¹⁴, —CO₂R¹⁵, -alkyl-COR¹⁶, and -alkyl-CO₂R¹⁷; and R¹⁴, R¹⁵, R¹⁶, and R¹⁷ are each independently, at each occurrence, selected from hydrogen, alkyl, and alkenyl.

In the foregoing imidazolines, R groups of carboxylic acid moieties can be absent where the R═H and the carboxylic acid moiety is deprotonated. For example, R¹⁵ and/or R¹⁷ can be absent where the R¹² and/or R¹³ is a deprotonated carboxylic acid moiety (e.g., where R¹² is —CH₂CH₂CO₂⁻). For an imidazoline compound, R¹ can be unsubstituted alkyl. For example, R¹ can be unsubstituted C₁-C₁₀-alkyl (e.g., methyl, ethyl, propyl (e.g., n-propyl, isopropyl), butyl (e.g., n-butyl, isobutyl, tert-butyl, sec-butyl), pentyl (e.g., n-pentyl, isopentyl, tert-pentyl, neopentyl, sec-pentyl, 3-pentyl), hexyl, heptyl, octyl, nonyl, or decyl). Further, R¹ can be unsubstituted C₂-C₁₀-alkyl. For the imidazoline compounds, R¹ can be unsubstituted C₂-C₈-alkyl. Further, R¹ can be unsubstituted C₂-C₆-alkyl. In some embodiments, R¹ is propyl, butyl, or hexyl.

In some embodiments, R¹ is a substituted alkyl. For example, R¹ may be a substituted C₁-C₁₀-alkyl, substituted C₂-C₁₀-alkyl, substituted C₂-C₈-alkyl, or substituted C₂-C₆-alkyl. Further, R¹ may be a C₁-C₁₀-alkyl, C₂-C₁₀-alkyl, C₂-C₈-alkyl, or C₂-C₆-alkyl, substituted with one substituent selected from —COR⁶, —CO₂R⁷, —SO₃R⁸, —PO₃H₂, —CON(R⁹)(R¹⁰), —OR¹¹, and —N(R¹²)(R¹³), wherein R⁶, R⁷, R⁸, R⁹, R¹⁰, R¹¹, R¹², and R¹³ are as defined above. More specifically, R¹ may be a C₂-C₆-alkyl, substituted with one substituent selected from —N(R¹²)(R¹³), wherein R¹² and R₁₃ are each independently selected from hydrogen, alkyl, —COR¹⁴, —CO₂R¹⁵, -alkyl-COR¹⁶, and -alkyl-CO₂R¹⁷, wherein R¹⁴, R¹⁵, R¹⁶, and R¹⁷ are as defined above. Further, R¹ may be a C₂-C₆-alkyl, substituted with one substituent selected from —N(R¹²)(R¹³), wherein R¹² and R₁₃ are each independently selected from hydrogen, C₂-C₆-alkyl, —COR¹⁴, —CO₂R¹⁵, —C₂-C₆-alkyl-COR¹⁶, and —C₂-C₆-alkyl-CO₂R¹⁷, wherein R¹⁴, R¹⁵, R¹⁶, and R¹⁷ are selected from hydrogen and C₁-C₃₄-alkyl. For these imidazolines, R¹ may be a linear C₂-C₆-alkyl, substituted with one substituent that is a terminal-N(R¹²)(R¹³), wherein R¹² and R₁₃ are each independently selected from hydrogen, —COR¹⁴, —CO₂R¹⁵, —C₂-C₆-alkyl-COR¹⁶, and —C₂-C₆-alkyl-CO₂R¹⁷, wherein R¹⁴, R¹⁵, R¹⁶, and R¹⁷ are selected from hydrogen and C₁-C₃₄-alkyl. For example, R¹ may be a linear C₂-alkyl, substituted with one substituent that is a terminal-N(R¹²)(R¹³), wherein R¹² is hydrogen and R¹³ is —COR¹⁴, wherein R¹⁴ is —C₁₇H₃₅, —C₁₇H₃₃, or —C₁₇H₃₁. Further, R¹ may be a linear C₂-alkyl, substituted with one substituent that is a terminal —N(R¹²)(R¹³), wherein R¹² and R₁₃ are each a —C₂-alkyl-CO₂R¹⁷, wherein R¹⁷ is hydrogen.

For the imidazolines of formulae (I), (II), and (III), R² may be a C₄-C₃₄-alkyl or C₄-C₃₄-alkenyl. For example, R² may be a —(CH₂)₃CH₃; —(CH₂)₄CH₃; —(CH₂)₅CH₃; —(CH₂)₆CH₃; —(CH₂)₇CH₃; —(CH₂)₈CH₃; —(CH₂)₉CH₃; —(CH₂)₁₀CH₃; —(CH₂)₁₁CH₃; —(CH₂)₁₂CH₃; —(CH₂)₁₃CH₃; —(CH₂)₁₄CH₃; —(CH₂)₁₅CH₃; —(CH₂)₁₆CH₃; —(CH₂)₁₇CH₃; —(CH₂)₁₈CH₃; —(CH₂)₁₉CH₃; —(CH₂)₂₀CH₃; —(CH₂)₂₁CH₃; —(CH₂)₂₂CH₃; —(CH₂)₂₃CH₃; —(CH₂)₂₄CH₃; —(CH₂)₂₅CH₃; —(CH₂)₂₆CH₃; —(CH₂)₂₇CH₃; —(CH₂)₂₈CH₃; —(CH₂)₂₉CH₃; —(CH₂)₃₀CH₃; —(CH₂)₃₁CH₃; —(CH₂)₃₂CH₃; —(CH₂)₃₃CH₃; —(CH₂)₃₄CH₃; —(CH₂)₂CH═CHCH₂CH—CHCH₂CH═CHCH₂CH—CHCH₂CH═CH(CH₂)₄CH₃; —(CH₂)₂CH═CHCH₂CH═CHCH₂CH═CHCH₂CH═CHCH₂CH═CHCH₂CH═CHCH₂CH₃; —(CH₂)₃CH═CHCH₂CH—CHCH₂CH═CH(CH₂)₇CH₃; —(CH₂)₃CH═CHCH₂CH₂CH—CHCH₂CH═CH(CH₂)₄CH₃; —(CH₂)₃CH═CH(CH₂)₄CH═CHCH₂CH═CH(CH₂)₄CH₃; —(CH₂)₃CH—CHCH₂CH—CHCH₂CH═CHCH₂CH═CH(CH₂)₄CH₃; —(CH₂)₃CH═CHCH₂CH—CHCH₂CH═CHCH₂CH═CHCH₂CH═CHCH₂CH₃; —(CH₂)₃CH═CHCH—CHCH═CHCH═CHCH═CH(CH₂)₄CH₃; —(CH₂)₄CH═CH(CH₂)₈CH₃; —(CH₂)₄CH═CHCH₂CH═CHCH₂CH═CH(CH₂)₄CH₃; —(CH₂)₄CH═CHCH₂CH═CHCH₂CH═CHCH₂CH═CHCH₂CH₃; —(CH₂)₄CH═CHCH₂CH═CHCH₂CH═CHCH₂CH—CHCH₂CH═CHCH₂CH₃; —(CH₂)₄CH═CHCH₂CH═CHCH₂CH═CHCH₂CH═CHCH₂CH═CH(CH₂)₄CH₃; —(CH₂)₄CH═CHCH₂CH═CHCH₂CH═CHCH₂CH═CHCH₂CH—CHCH₂CH═CHCH₂CH₃; —(CH₂)₅CH=CHCH₂CH—CHCH₂CH=CHCH₂CH₃; —(CH₂)₅CH═CHCH₂CH═CHCH₂CH═CHCH₂CH═CH(CH₂)₄CH₃; —(CH₂)₅CH═CHCH₂CH═CHCH₂CH—CHCH₂CH—CHCH₂CH═CHCH₂CH₃; —(CH₂)₆CH═CHCH═CHCH═CH(CH₂)₄CH₃; —(CH₂)₆CH═CHCH₂CH—CHCH₂CH—CHCH₂CH═CH(CH₂)₄CH₃; —(CH₂)₇CH═CH(CH₂)₃CH₃; —(CH₂)₇CH═CH(CH₂)₅CH₃; —(CH₂)₇CH═CH(CH₂)₇CH₃; —(CH₂)₇CH═CHCH—CHCH═CH(CH₂)₃CH₃; —(CH₂)₇CH═CHCH═CH(CH₂)₅CH₃; —(CH₂)₇CH═CHCH₂CH═CH(CH₂)₄CH₃; —(CH₂)₇CH═CHCH₂CH═CH(CH₂)₄CH₃; —(CH₂)₇CH═CHCH═CHCH₂CH₂CH═CHCH₂CH₃; —(CH₂)₇CH═CHCH—CHCH═CHCH—CHCH₂CH₃; —(CH₂)₇CH═CHCH₂CH—CHCH₂CH—CHCH₂CH═CH(CH₂)₄CH₃; —(CH₂)₇CH═CHCH₂CH═CHCH₂CH═CHCH₂CH₃; —(CH₂)₇CH═CHCH₂CH═CHCH₂CH═CHCH₂CH═CHCH₂CH═CHCH₂CH₃; —(CH₂)₉CH═CH(CH₂)₅CH₃; —(CH₂)₉CH═CHCH₂CH═CH(CH₂)₄CH₃; —(CH₂)₉CH═CHCH₂CH═CHCH₂CH═CHCH₂CH₃; —(CH₂)₉CH═CH(CH₂)₇CH₃; —(CH₂)₁₁CH═CH(CH₂)₅CH₃; —(CH₂)₁₁CH═CH(CH₂)₇CH₃; —(CH₂)₁₁CH═CHCH₂CH═CH(CH₂)₄CH₃; or —(CH₂)₁₃CH═CH(CH₂)₇CH₃.

In some embodiments, R² may be a radical derived from a saturated or unsaturated fatty acid. Suitable saturated fatty acids include, but are not limited to, butyric acid, valeric acid, caproic acid, enanthic acid, caprylic acid, pelargonic acid, capric acid, undecylic acid, lauric acid, tridecylic acid, myristic acid, pentadecylic acid, palmitic acid, margaric acid, stearic acid, nonadecylic acid, arachidic acid, heneicosylic acid, behenic acid, tricosylic acid, lignoceric acid, pentacosylic acid, cerotic acid, heptacosylic acid, montanic acid, nonacosylic acid, melissic acid, henatriacontylic acid, lacceroic acid, psyllic acid, geddic acid, ceroplastic acid, and hexatriacontylic acid. Suitable unsaturated fatty acids include, but are not limited to, myristoleic acid, palmitoleic acid, sapienic acid, oleic acid, elaidic acid, vaccenic acid, linoleic acid, linoelaidic acid, α-linolenic acid, arachidonic acid, eicosapentaenoic acid, erucic acid, docosahexaenoic acid, hexadecatrienoic acid, stearidonic acid, eicosatrienoic acid, eicosatetraenoic acid, heneicosapentaenoic acid, clupanodonic acid, osbond acid, (9Z,12Z,15Z,18Z,21Z)-tetracosa-9,12,15,18,21-pentaenoic acid, nisinic acid, γ-linolenic acid, eicosadienoic acid, dihomo-γ-linolenic acid, docosadienoic acid, adrenic acid, tetracosatetraenoic acid, (6Z,9Z,12Z,15Z,18Z)-tetracosa-6,9,12,15,18-pentaenoic acid, (Z)-Eicos-11-enoic acid, mead acid, erucic acid, nervonic acid, rumenic acid, α-calendic acid, β-calendic acid, jacaric acid, α-eleostearic acid, β-eleostearic acid, catalpic acid, punicic acid, rumelenic acid, α-parinaric acid, β-parinaric acid, bosseopentaenoic acid, pinolenic acid, and podocarpic acid. In some embodiments, R² is derived from coconut oil, beef tallow, or tall oil fatty acid (TOFA).

In some embodiments, R³ may be —C(R^{a}R^{b})—C(R^{c}R^{d})—CO₂R^{e}, wherein R^{a}, R^{b}, R^{c}, and R^{d} are each independently selected from the group consisting of hydrogen (—H), halogen, and alkyl, and wherein R^{e} is hydrogen (—H) or alkyl. For example, R³ may be —C(R^{a}R^{b})—C(R^{c}R^{d})—CO₂R^{e}, wherein R^{a}, R^{b}, R^{c}, and R^{d} are each independently selected from the group consisting of hydrogen (—H), halogen, and C₁-C₆-alkyl, and wherein R^{e} is hydrogen (—H) or C₁-C₆-alkyl. Further, R³ may be —CH₂CH₂CO₂R^{e}, wherein R^{e} is hydrogen (—H) or C₁-C₆-alkyl. Additionally, R^{e} can be absent where the R³ is a deprotonated carboxylic acid moiety (e.g., where R³ is —CH₂CH₂CO₂—).

In accordance with certain embodiments of the present disclosure, R³ can be derived from an acrylic acid. Suitable acrylic acids include, but are not limited to, acrylic acid, methacrylic acid, 2-ethylacrylic acid, 2-propylacrylic acid, and 2-(trifluoromethyl) acrylic acid. For example, R³ can be derived from acrylic acid (H₂C═CHCO₂H).

Imidazolines of formulae (I), (II), or (III) may have R^{x} equal to —C(R^{a}R^{b})—C(R^{c}R^{d})—CO₂R^{e}, wherein R^{a}, R^{b}, R^{c}, and R^{d} are each independently selected from the group consisting of hydrogen (—H), halogen, and alkyl, and wherein R^{e} is hydrogen (—H) or alkyl. Further, R^{x} can be —C(R^{a}R^{b})—C(R^{c}R^{d})— CO₂R^{e}, wherein R^{a}, R^{b}, R^{c}, and R^{d} are each independently selected from the group consisting of hydrogen (—H), halogen, and C₁-C₆-alkyl, and wherein R^{e} is hydrogen (—H) or C₁-C₆-alkyl. Additionally, R^{x} may be —CH₂CH₂CO₂R^{e}, wherein R^{e} is hydrogen (—H) or C₁-C₆-alkyl. Further, R^{e} can be absent where the R^{x} is a deprotonated carboxylic acid moiety (e.g., where Rₓ is —CH₂CH₂CO₂—).

For the imidazolines described herein, R^{x} can be derived from an acrylic acid. Suitable acrylic acids include, but are not limited to, acrylic acid, methacrylic acid, 2-ethylacrylic acid, 2-propylacrylic acid, and 2-(trifluoromethyl) acrylic acid. For example, R^{x} can be derived from acrylic acid (H₂C═CHCO₂H).

Imidazolines of formulae (I), (II), or (III) can have R⁴ and R⁵ each independently be an unsubstituted C₁-C₁₀-alkyl (e.g., methyl, ethyl, propyl (e.g., n-propyl, isopropyl), butyl (e.g., n-butyl, isobutyl, tert-butyl, sec-butyl), pentyl (e.g., n-pentyl, isopentyl, tert-pentyl, neopentyl, sec-pentyl, 3-pentyl), hexyl, heptyl, octyl, nonyl, or decyl) or hydrogen. Further, R⁴ and R⁵ can each independently be an unsubstituted C₁-C₆ alkyl group or hydrogen. In some embodiments, R⁴ and R⁵ are each hydrogen (—H).

Imidazolines of formulae (I), (II), or (III) can have R⁶, R⁷, R⁸, R⁹, R¹⁰, and R¹¹ each independently be, at each occurrence, selected from hydrogen, unsubstituted alkyl, and unsubstituted alkenyl. For example, R⁶, R⁷, R⁸, R⁹, R¹⁰, and R¹¹ can each independently be, at each occurrence, selected from hydrogen, unsubstituted C₁-C₃₄-alkyl, and unsubstituted C₂-C₃₄-alkenyl. Further, R⁶, R⁷, R⁸, R⁹, R¹⁰, and R¹¹ can each independently be, at each occurrence, selected from hydrogen, unsubstituted C₁-C₁₀-alkyl, and unsubstituted C₂-C₁₀-alkenyl. Further, R⁶, R⁷, R⁸, R⁹, R¹⁰, and R¹¹ can each independently be, at each occurrence, selected from hydrogen, and a radical derived from a fatty acid.

R¹² and R₁₃ can each independently be, at each occurrence, selected from hydrogen, C₁-C₁₀-alkyl, —COR¹⁴, —CO₂R¹⁵, —C₁-C₁₀-alkyl-COR¹⁶, and —C₁-C₁₀-alkyl-CO₂R¹⁷. Further, R¹² and R₁₃ can each independently be, at each occurrence, selected from hydrogen, unsubstituted C₁-C₁₀-alkyl, —COR¹⁴, —CO₂R¹⁵, —C₁-C₁₀-alkyl-COR¹⁶, and —C₁-C₁₀-alkyl-CO₂R¹⁷.

R¹⁴, R¹⁵, R¹⁶, and R¹⁷ can each independently be, at each occurrence, selected from hydrogen, unsubstituted alkyl, and unsubstituted alkenyl. Further, R¹⁴, R¹⁵, R¹⁶, and R¹⁷ can each independently be, at each occurrence, selected from hydrogen, unsubstituted C₁-C₃₄-alkyl, and unsubstituted C₂-C₃₄-alkenyl. Additionally, R¹⁴, R¹⁵, R¹⁶, and R¹⁷ can each independently be, at each occurrence, selected from hydrogen, unsubstituted C₁-C₁₀-alkyl, and unsubstituted C₂-C₁₀-alkenyl. Further, R¹⁵ and/or R¹⁷ can be absent where the carboxylic acid moiety is deprotonated.

Imidazoline compounds of the present disclosure can have R¹⁴, R¹⁵, R¹⁶, and R¹⁷ each independently be, at each occurrence, selected from hydrogen, and a radical derived from a fatty acid. Further, R¹⁴, R¹⁵, R¹⁶, and R¹⁷ can each independently be, at each occurrence, selected from hydrogen, C₄-C₃₄-alkyl, and C₄-C₃₄-alkenyl. Additionally, R¹⁴, R¹⁵, R¹⁶, and R¹⁷ can each independently be, at each occurrence, selected from hydrogen; —(CH₂)₃CH₃; —(CH₂)₄CH₃; —(CH₂)₅CH₃; —(CH₂)₆CH₃; —(CH₂)₇CH₃; —(CH₂)₈CH₃; —(CH₂)₉CH₃; —(CH₂)₁₀CH₃; —(CH₂)₁₁CH₃; —(CH₂)₁₂CH₃; —(CH₂)₁₃CH₃; —(CH₂)₁₄CH₃; —(CH₂)₁₅CH₃; —(CH₂)₁₆CH₃; —(CH₂)₁₇CH₃; —(CH₂)₁₈CH₃; —(CH₂)₁₉CH₃; —(CH₂)₂₀CH₃; —(CH₂)₂₁CH₃; —(CH₂)₂₂CH₃; —(CH₂)₂₃CH₃; —(CH₂)₂₄CH₃; —(CH₂)₂₅CH₃; —(CH₂)₂₆CH₃; —(CH₂)₂₇CH₃; —(CH₂)₂₈CH₃; —(CH₂)₂₉CH₃; —(CH₂)₃₀CH₃; —(CH₂)₃₁CH₃; —(CH₂)₃₂CH₃; —(CH₂)₃₃CH₃; —(CH₂)₃₄CH₃; —(CH₂)₂CH═CHCH₂CH═CHCH₂CH═CHCH₂CH═CHCH₂CH═CH(CH₂)₄CH₃; —(CH₂)₂CH═CHCH₂CH—CHCH₂CH═CHCH₂CH═CHCH₂CH═CHCH₂CH═CHCH₂CH₃; —(CH₂)₃CH═CHCH₂CH—CHCH₂CH═CH(CH₂)₇CH₃; —(CH₂)₃CH═CHCH₂CH₂CH═CHCH₂CH═CH(CH₂)₄CH₃; —(CH₂)₃CH—CH(CH₂)₄CH═CHCH₂CH═CH(CH₂)₄CH₃; —(CH₂)₃CH═CHCH₂CH—CHCH₂CH═CHCH₂CH═CH(CH₂)₄CH₃; —(CH₂)₃CH═CHCH₂CH═CHCH₂CH—CHCH₂CH—CHCH₂CH═CHCH₂CH₃; —(CH₂)₃CH═CHCH═CHCH—CHCH—CHCH═CH(CH₂)₄CH₃; —(CH₂)₄CH—CH(CH₂)₈CH₃; —(CH₂)₄CH═CHCH₂CH═CHCH₂CH═CH(CH₂)₄CH₃; —(CH₂)₄CH═CHCH₂CH═CHCH₂CH═CHCH₂CH═CHCH₂CH₃; —(CH₂)₄CH═CHCH₂CH═CHCH₂CH═CHCH₂CH═CHCH₂CH—CHCH₂CH₃; —(CH₂)₄CH═CHCH₂CH═CHCH₂CH═CHCH₂CH═CHCH₂CH═CH(CH₂)₄CH₃; —(CH₂)₄CH═CHCH₂CH═CHCH₂CH—CHCH₂CH═CHCH₂CH═CHCH₂CH═CHCH₂CH₃; —(CH₂)₅CH═CHCH₂CH═CHCH₂CH═CHCH₂CH₃; —(CH₂)₅CH═CHCH₂CH═CHCH₂CH═CHCH₂CH═CH(CH₂)₄CH₃; —(CH₂)₅CH═CHCH₂CH—CHCH₂CH═CHCH₂CH═CHCH₂CH═CHCH₂CH₃; —(CH₂)₆CH═CHCH═CHCH═CH(CH₂)₄CH₃; —(CH₂)₆CH═CHCH₂CH—CHCH₂CH—CHCH₂CH═CH(CH₂)₄CH₃; —(CH₂)₇CH═CH(CH₂)₃CH₃; —(CH₂)₇CH═CH(CH₂)₅CH₃; —(CH₂)₇CH═CH(CH₂)₇CH₃; —(CH₂)₇CH═CHCH═CHCH═CH(CH₂)₃CH₃; —(CH₂)₇CH═CHCH═CH(CH₂)₅CH₃; —(CH₂)₇CH═CHCH₂CH═CH(CH₂)₄CH₃; —(CH₂)₇CH═CHCH₂CH═CH(CH₂)₄CH₃; —(CH₂)₇CH═CHCH—CHCH₂CH₂CH═CHCH₂CH₃; —(CH₂)₇CH═CHCH═CHCH═CHCH═CHCH₂CH₃; —(CH₂)₇CH═CHCH₂CH—CHCH₂CH—CHCH₂CH═CH(CH₂)₄CH₃; —(CH₂)₇CH═CHCH₂CH═CHCH₂CH═CHCH₂CH₃; —(CH₂)₇CH═CHCH₂CH═CHCH₂CH═CHCH₂CH═CHCH₂CH═CHCH₂CH₃; —(CH₂)₉CH═CH(CH₂)₅CH₃; —(CH₂)₉CH═CHCH₂CH═CH(CH₂)₄CH₃; —(CH₂)₉CH═CHCH₂CH═CHCH₂CH═CHCH₂CH₃; —(CH₂)₉CH═CH(CH₂)₇CH₃; —(CH₂)₁₁CH═CH(CH₂)₅CH₃; —(CH₂)₁₁CH═CH(CH₂)₇CH₃; —(CH₂)₁₁CH═CHCH₂CH═CH(CH₂)₄CH₃; and —(CH₂)₁₃CH═CH(CH₂)₇CH₃.

For the imidazolines of formulae (I), (II), and (III), R¹⁴, R¹⁵, R¹⁶, and R¹⁷ can each independently be, at each occurrence, selected from hydrogen, a radical derived from a saturated fatty acid, and a radical derived from an unsaturated fatty acid. Suitable saturated fatty acids include, but are not limited to, butyric acid, valeric acid, caproic acid, enanthic acid, caprylic acid, pelargonic acid, capric acid, undecylic acid, lauric acid, tridecylic acid, myristic acid, pentadecylic acid, palmitic acid, margaric acid, stearic acid, nonadecylic acid, arachidic acid, heneicosylic acid, behenic acid, tricosylic acid, lignoceric acid, pentacosylic acid, cerotic acid, heptacosylic acid, montanic acid, nonacosylic acid, melissic acid, henatriacontylic acid, lacceroic acid, psyllic acid, geddic acid, ceroplastic acid, and hexatriacontylic acid. Suitable unsaturated fatty acids include, but are not limited to, myristoleic acid, palmitoleic acid, sapienic acid, oleic acid, elaidic acid, vaccenic acid, linoleic acid, linoelaidic acid, α-linolenic acid, arachidonic acid, eicosapentaenoic acid, erucic acid, docosahexaenoic acid, hexadecatrienoic acid, stearidonic acid, eicosatrienoic acid, eicosatetraenoic acid, heneicosapentaenoic acid, clupanodonic acid, osbond acid, (9Z,12Z,15Z,18Z,21Z)-tetracosa-9,12,15,18,21-pentaenoic acid, nisinic acid, γ-linolenic acid, eicosadienoic acid, dihomo-γ-linolenic acid, docosadienoic acid, adrenic acid, tetracosatetraenoic acid, (6Z,9Z,12Z,15Z,18Z)-tetracosa-6,9,12,15,18-pentaenoic acid, (Z)-Eicos-11-enoic acid, mead acid, erucic acid, nervonic acid, rumenic acid, α-calendic acid, β-calendic acid, jacaric acid, α-eleostearic acid, β-eleostearic acid, catalpic acid, punicic acid, rumelenic acid, α-parinaric acid, β-parinaric acid, bosseopentaenoic acid, pinolenic acid, and podocarpic acid.

Further, R¹⁴, R¹⁵, R¹⁶, and R¹⁷ are each independently, at each occurrence, hydrogen or a radical derived from coconut oil, beef tallow, or TOFA.

In some embodiments, the imidazoline is a compound of formula (I), wherein R¹ is unsubstituted C₂-C₆-alkyl; R² is —C₁₇H₃₅, —C₁₇H₃₃, or —C₁₇H₃₁; R³ is —CH₂CH₂CO₂R^{e}, wherein R^{e} is hydrogen (—H), C₁-C₆-alkyl, or R^{e} is absent (e.g., R³ is —CH₂CH₂CO₂—); R⁴ is hydrogen; and R⁵ is hydrogen.

In some embodiments, the imidazoline is a compound of formula (I), wherein R¹ is linear C₂-alkyl, substituted with one substituent that is a terminal-N(R¹²)(R¹³), wherein R¹² is hydrogen and R¹³ is —COR¹⁴ wherein R¹⁴ is —C₁₇H₃₅, —C₁₇H₃₃, or —C₁₇H₃₁; R² is —C₁₇H₃₅, —C₁₇H₃₃, or —C₁₇H₃₁; R³ is —CH₂CH₂CO₂R^{e}, wherein R^{e} is hydrogen (—H), C₁-C₆-alkyl, or R^{e} is absent (e.g., R³ is —CH₂CH₂CO₂—); R⁴ is hydrogen; and R⁵ is hydrogen.

In certain embodiments, the imidazoline is a compound of formula (I), wherein R¹ is linear C₂-alkyl, substituted with one substituent that is a terminal-N(R¹²)(R¹³), wherein R¹² and R₁₃ are each a —C₂-alkyl-CO₂R¹⁷, wherein R¹⁷ is hydrogen or is absent (e.g., R¹² is —C₂-alkyl-CO₂—); R² is —C₁₇H₃₅, —C₁₇H₃₃, or —C₁₇H₃₁; R³ is —CH₂CH₂CO₂R^{e}, wherein R^{e} is hydrogen (—H), C₁-C₆-alkyl, or R^{e} is absent (e.g., R³ is —CH₂CH₂CO₂—); R⁴ is hydrogen; and R⁵ is hydrogen.

In some embodiments, the imidazoline is a compound of formula (II), wherein R¹ is unsubstituted C₂-C₆-alkyl; R² is —C₁₇H₃₅, —C₁₇H₃₃, or —C₁₇H₃₁; R³ is —CH₂CH₂CO₂R^{e}, wherein R^{e} is hydrogen (—H), C₁-C₆-alkyl, or R^{e} is absent (e.g., R³ is —CH₂CH₂CO₂—); R^{x} is —CH₂CH₂CO₂R^{e}, wherein R^{e} is hydrogen (—H), C₁-C₆-alkyl, or R^{e} is absent (e.g., R^{x} is —CH₂CH₂CO₂—); R⁴ is hydrogen; and R⁵ is hydrogen.

In some embodiments, the imidazoline is a compound of formula (II), wherein R¹ is linear C₂-alkyl, substituted with one substituent that is a terminal-N(R¹²)(R¹³), wherein R¹² is hydrogen and R¹³ is —COR¹⁴, wherein R¹⁴ is —C₁₇H₃₅, —C₁₇H₃₃, or —C₁₇H₃₁; R² is —C₁₇H₃₅, —C₁₇H₃₃, or —C₁₇H₃₁; R³ is —CH₂CH₂CO₂R^{e}, wherein R^{e} is hydrogen (—H), C₁-C₆-alkyl, or R^{e} is absent (e.g., R³ is —CH₂CH₂CO₂—); R^{x} is —CH₂CH₂CO₂R^{e}, wherein R^{e} is hydrogen (—H), C₁-C₆-alkyl, or R^{e} is absent (e.g., R^{x} is —CH₂CH₂CO₂—); R⁴ is hydrogen; and R⁵ is hydrogen.

In certain embodiments, the imidazoline can be a compound of formula (II), wherein R¹ is linear C₂-alkyl, substituted with one substituent that is a terminal —N(R¹²)(R¹³), wherein R¹² and R₁₃ are each a —C₂-alkyl-CO₂R¹⁷, wherein R¹⁷ is hydrogen or is absent (e.g., R¹² is —C₂-alkyl-CO₂—); R² is —C₁₇H₃₅, —C₁₇H₃₃, or —C₁₇H₃₁; R³ is —CH₂CH₂CO₂R^{e}, wherein R^{e} is hydrogen (—H), C₁—C₆-alkyl, or R^{e} is absent (e.g., R³ is —CH₂CH₂CO₂—); R^{x} is —CH₂CH₂CO₂R^{e}, wherein R^{e} is hydrogen (—H), C₁-C₆-alkyl, or R^{e} is absent (e.g., R^{x} is —CH₂CH₂CO₂—); R⁴ is hydrogen; and R⁵ is hydrogen.

In some embodiments, the imidazoline can be a compound of formula (III), wherein R¹ is unsubstituted C₂-C₆-alkyl; R² is —C₁₇H₃₅, —C₁₇H₃₃, or —C₁₇H₃₁; R⁴ is hydrogen; and R⁵ is hydrogen.

In some embodiments, the imidazoline can be a compound of formula (III), wherein R¹ is linear C₂-alkyl, substituted with one substituent that is a terminal —N(R¹²)(R¹³), wherein R¹² is hydrogen and R¹³ is —COR¹⁴, wherein R¹⁴ is —C₁₇H₃₅, —C₁₇H₃₃, or —C₁₇H₃₁; R² is —C₁₇H₃₅, —C₁₇H₃₃, or —C₁₇H₃₁; R⁴ is hydrogen; and R⁵ is hydrogen.

In certain embodiments, the imidazoline can be a compound of formula (III), wherein R¹ is linear C₂-alkyl, substituted with one substituent that is a terminal —N(R¹²)(R¹³), wherein R¹² and R₁₃ are each a —C₂-alkyl-CO₂R¹⁷, wherein R¹⁷ is hydrogen or is absent (e.g., R¹² is —C₂-alkyl-CO₂″); R² is —C₁₇H₃₅, —C₁₇H₃₃, or —C₁₇H₃₁; R⁴ is hydrogen; and R⁵ is hydrogen.

It is to be understood, whether explicitly set forth or not, that formula (I), formula (II), and formula (III) are each intended to encompass the tautomeric, racemic, enantiomeric, diastereomeric, zwitterionic, and salt forms of said formulas. The imidazolines can exist in a zwitterionic form where R³ and/or R^{x} is derived from an acrylic acid.

The second reaction product of the composition may be produced by reacting a second amine with a second carboxylic acid. In some embodiments, the second reaction product comprises an amide-containing compound, such as a TOFA/diethylene triamine (DETA) amide or a TOFA/tetraethylene pentamine (TEPA) amide.

The first carboxylic acid and the second carboxylic acid may be independently selected from any fatty acid. For example, the fatty acid may be TOFA, a C₁₆ fatty acid, a C₁₇ fatty acid, a C₁₈ fatty acid, and any combination thereof. The first carboxylic acid and the second carboxylic acid may be the same or they may be different.

The first amine and the second amine may be independently selected from the group consisting of TEPA, triethylene tetramine (TETA), pentaethylene hexamine (PEHA), hexaethylene heptamine (HEHA), higher carbon number homologues, and any combination thereof. The first amine and the second amine may be the same or they may be different.

The dimer acid of the compositions disclosed herein may be selected from the group consisting of a C₁₀-C₄₀ fatty acid, such as a C₁₀-C₃₆ fatty acid, a C₁₀-C₃₂ fatty acid, a C₁₀-C₂₈ fatty acid, a C₁₀-C₂₄ fatty acid, a C₁₀-C₂₀ fatty acid, a C₁₀-C₁₈ fatty acid, a C₁₀-C₁₆ fatty acid, a C₁₀-C₁₄ fatty acid, a C₁₀-C₁₂ fatty acid, a C₁₂-C₂₀ fatty acid, a C₁₄-C₂₀ fatty acid, a C₁₆-C₂₀ fatty acid, a C₁₈-C₂₀ fatty acid, a C₁₀ fatty acid, a C₁₁ fatty acid, a C₁₂ fatty acid, a C₁₃ fatty acid, a C₁₄ fatty acid, a C₁₅ fatty acid, a C₁₆ fatty acid, a C₁₇ fatty acid, a C₁₈ fatty acid, a C₁₉ fatty acid, a C₂₀ fatty acid, a C₂₄ fatty acid, a C₂₈ fatty acid, a C₃₂ fatty acid, or a C₃₆ fatty acid.

For example, the dimer acid may comprise 9-[(Z)-non-3-enyl]-10-octylnonadecanedioic acid (CAS No. 61788-89-4). The dimer acid may be an aromatic dimer, a polycyclic dimer, or octadecadienoic acid, for example.

The dimer acid may be a single dimer acid or the dimer acid may be a mixture of dimer acids or a mixture of various acids with the mixture comprising the dimer acid in the greatest concentration. For example, a dimer acid mixture may comprise stearic acid, the dimer acid, a trimer acid, and a tetramer acid. The mixture may comprise, for example, from about 1 wt. % to about 10 wt. % of the stearic acid, from about 65 wt. % to about 85 wt. % of the dimer acid, about 5 wt. % to about 20 wt. % of the trimer acid, and about 1 wt. % to about 15 wt. % of the tetramer acid. In some embodiments, the mixture may comprise about 5 wt. % of the stearic acid, from about 76 wt. % of the dimer acid, about 13 wt. % of the trimer acid, and about 6 wt. % of the tetramer acid.

The trimer acid may be selected from the group consisting of a C₁₀-C₂₀ fatty acid, such as a C₁₀-C₁₈ fatty acid, a C₁₀-C₁₆ fatty acid, a C₁₀-C₁₄ fatty acid, a C₁₀-C₁₂ fatty acid, a C₁₂-C₂₀ fatty acid, a C₁₄-C₂₀ fatty acid, a C₁₆-C₂₀ fatty acid, a C₁₈-C₂₀ fatty acid, a C₁₀ fatty acid, a C₁₁ fatty acid, a C₁₂ fatty acid, a C₁₃ fatty acid, a C₁₄ fatty acid, a C₁₅ fatty acid, a C₁₆ fatty acid, a C₁₇ fatty acid, a C₁₈ fatty acid, a C₁₉ fatty acid, or a C₂₀ fatty acid.

The trimer acid may be a single trimer acid or the trimer acid may be a mixture of trimer acids or a mixture of various acids with the mixture comprising the trimer acid in the greatest concentration. For example, a trimer acid mixture may comprise a dimer acid, a trimer acid, and a tetramer acid. The mixture may comprise, for example, from about 15 wt. % to about 35 wt. % of the dimer acid, about 45 wt. % to about 65 wt. % of the trimer acid, and about 10 wt. % to about 30 wt. % of the tetramer acid. In some embodiments, the mixture may comprise about 26 wt. % of the dimer acid, about 54 wt. % of the trimer acid, and about 20 wt. % of the tetramer acid.

The dimer acid may be produced by, for example, dimerization of a linear unsaturated fatty acid or unsaturated fatty acid ester with linoleic acid. Similarly, the trimer acid may be produced by, for example, trimerization of a linear unsaturated fatty acid or unsaturated fatty acid ester with linoleic acid. Likewise, the tetramer acid may be produced by, for example, tetramerization of a linear unsaturated fatty acid or unsaturated fatty acid ester with linoleic acid.

The viscosifier dimer acid present in the compositions disclosed herein may be, for example, selected from the group consisting of 9-[(Z)-non-3-enyl]-10-octylnonadecanedioic acid (CAS No. 61788-89-4), dilinoleic acid, or a compound comprising the molecular formula C₃₆H₆₈O₄. In some embodiments, the viscosifier dimer acid may be the same as the dimer acid or it may be different.

The solvent that may be used with the compositions and methods disclosed herein may be an organic solvent in certain embodiments. In some embodiments, the solvent may be selected from the group consisting of heavy reformate, light aromatic naphtha, xylene, toluene, and any combination thereof.

The compositions disclosed herein may comprise various amounts of the components.

For example, the composition may comprise from about 5 wt. % to about 25 wt. % of the first reaction product, such as from about 10 wt. % to about 25 wt. %, about 15 wt. % to about 25 wt. %, about 20 wt. % to about 25 wt. %, about 5 wt. % to about 20 wt. %, about 5 wt. % to about 15 wt. %, or about 5 wt. % to about 10 wt. % of the first reaction product.

The composition may also comprise from about 5 wt. % to about 25 wt. % of the second reaction product, such as from about 10 wt. % to about 25 wt. %, about 15 wt. % to about 25 wt. %, about 20 wt. % to about 25 wt. %, about 5 wt. % to about 20 wt. %, about 5 wt. % to about 15 wt. %, or about 5 wt. % to about 10 wt. % of the second reaction product.

With respect to the trimer acid, a composition may comprise from about 5 wt. % to about 15 wt. %, such as about 5 wt. % to about 10 wt. %, about 10 wt. % to about 15 wt. %, about 5 wt. %, about 7 wt. %, about 9 wt. %, about 11 wt. %, about 13 wt. %, or about 15 wt. % of the trimer acid.

With respect to the solvent, a composition of the present disclosure may comprise from about 20 wt. % to about 80 wt. % of the solvent, such as from about 20 wt. % to about 70 wt. %, about 20 wt. % to about 60 wt. %, about 20 wt. % to about 50 wt. %, about 20 wt. % to about 40 wt. %, about 20 wt. % to about 30 wt. %, about 30 wt. % to about 70 wt. %, about 40 wt. % to about 70 wt. %, about 50 wt. % to about 70 wt. %, or about 60 wt. % to about 70 wt. % of the solvent.

Finally, a composition of the present disclosure may comprises from about 5 wt. % to about 25 wt. % of the viscosifier dimer acid, such as from about 5 wt. % to about 20 wt. %, about 5 wt. % to about 15 wt. %, about 5 wt. % to about 10 wt. %, about 10 wt. % to about 20 wt. %, about 15 wt. % to about 20 wt. %, about 6 wt. %, about 8 wt. %, about 10 wt. %, about 12 wt. %, about 14 wt. %, about 16 wt. %, about 18 wt. %, about 20 wt. %, about 22 wt. %, or about 24 wt. % of the viscosifier dimer acid.

In some embodiments of the present disclosure, a composition comprises a ratio of the viscosifier dimer acid to the trimer acid of greater than 1:1, such as from greater than about 1:1 (e.g., 1.1:1) to about 100:1, from about 2:1 to about 100:1, from about 5:1 to about 100:1, from about 10:1 to about 100:1, from about 20:1 to about 100:1, from about 30:1 to about 100:1, from about 40:1 to about 100:1, from about 50:1 to about 100:1, from about 1:1 to about 90:1, from about 1:1 to about 80:1, from about 1:1 to about 70:1, from about 1:1 to about 60:1, from about 1:1 to about 50:1, from about 1:1 to about 40:1, from about 1:1 to about 30:1, from about 1:1 to about 20:1, or from about 1:1 to about 10:1.

In certain aspects of the present disclosure, the inventors discovered that the higher the viscosity of the product/composition/corrosion inhibitor, the better the performance. In certain embodiments, the viscosifier dimer acid is thus added to the composition to adjust (e.g., increase) the viscosity of the corrosion inhibitor composition. The inventors also unexpectedly discovered that the viscosifier dimer acid may react with the cyclic amine in the formulation and create a salt, which may further boost corrosion inhibition performance.

In some embodiments, the composition comprises a viscosity from about 50 cP to about 350 cP, such as from about 100 cP to about 350 cP, about 150 cP to about 350 cP, about 200 cP to about 350 cP, about 250 cP to about 350 cP, about 300 cP to about 350 cP, about 50 cP to about 300 cP, about 50 cP to about 250 cP, about 50 cP to about 200 cP, about 50 cP to about 150 cP, or about 50 cP to about 100 cP.

The compositions disclosed herein may optionally comprise one or more additional components. The additional component may be added to the medium before, after, and/or simultaneously with the corrosion inhibitor composition.

In some embodiments, the additional component comprises a stabilizer, a hydroxycarboxylic acid, a sulfonated homopolymer, a sulfonated copolymer, a scale inhibitor, a polyol, a polycarboxylic acid, a chelant, or any combination thereof.

In some embodiments, the stabilizer includes a polymer dispersant which is a polymer of at least one monomeric component selected from the group consisting of acrylamidomethanesulfonic acid, dimethyl-2-oxobut-3-en-1-yl-ammonio-methanesulfonate, allyloxypolyethoxy(10) sulfonic acid, 2-acrylamido-2-methylpropane sulfonic acid (i.e., 2-acrylamido-2-methyl-1-propanesulfonic acid or AMPS), 2-acrylamido-2-methylbutane sulfonic acid, acrylamide tertbutylsulfonate, 4-(allyloxy)benzenesulfonic acid, styrene sulfonic acid, allyl sulfonic acid, methallyl sulfonic acid, allyl hydroxypropane sulfonic acid, salts thereof, and any combination thereof.

In some embodiments, the stabilizer includes a polyol selected from the group consisting of a polyglycerol; a branched polyglycerol; a cyclic polyglycerol; a hyperbranched polyglycerol; polypropylene glycol; pentaerythritol ethoxylate; carboxymethylated polyglycerol, polypropylene glycol, pentaerythritol ethoxylate, and sorbitol; hydroxycarboxalkylated polyglycerol, polypropylene glycol, pentaerythritol ethoxylate, and sorbitol; and hydroxysulfoalkylated polyglycerol, polypropylene glycol, pentaerythritol ethoxylate, and sorbitol.

In some embodiments, the chelant is selected from the group consisting of ethylenediamine tetra acetic acid, nitrilotriacetic acid, a polymer comprising maleic acid, a polymer comprising acrylic acid, and any combination thereof.

Illustrative, non-limiting examples of scale inhibitors that can be used in connection with the compositions disclosed herein include one or more of a polyacrylate, a polymaleic anhydride, an alkyl epoxy carboxylate, polyepoxy succinic acid, polyaspartic acid, a polyacrylamide copolymer, an acrylic acid and hydroxypropylacrylate copolymer, and any combination thereof.

The polycarboxylic acid disclosed herein may function as a scale inhibitor. It will be appreciated that the polycarboxylic acid component may be a carboxylic acid, as discussed above, or a residue of a molecule having at least two carboxyl moieties, e.g., dicarboxylic acids, tricarboxylic acids, tetracarboxylic acids, etc. In some embodiments, the polycarboxylic acid component is a copolymer. The copolymer may comprise, consist essentially of, or consist of a polymerized residue of two or more monomers. The two or more monomers may include a first monomer comprising, consisting essentially of, or consisting of a carboxylic acid or a residue thereof and a second monomer, which is different than the first monomer. The first monomer may include a carboxylic acid or a residue of a molecule having at least one carboxyl moiety, a salt thereof, or a conjugate base thereof. The carboxylic acid may include a single carboxyl moiety or a plurality of carboxyl moieties (e.g., dicarboxylic acids, such as maleic acid, etc.).

Each of the constituent components of the compositions disclosed herein can be provided in any form, such as liquid or solid form, and mixed together. After mixing and formation of the resulting composition, the composition may, in certain aspects, be chemically homogenous throughout. In other words, each portion of the composition may have the same constituent components in substantially the same relative weight percentages as each other portion of the composition.

Additional examples of components that may be present in the compositions of the present disclosure include, but are not limited to, a fouling control agent, an additional corrosion inhibitor, a biocide, a preservative, an acid, a hydrogen sulfide scavenger, a surfactant, a pH modifier, a coagulant/flocculant agent, a water clarifier, a dispersant, an antioxidant, a polymer degradation prevention agent, a permeability modifier, a CO₂ scavenger, an O₂ scavenger, a gelling agent, a lubricant, a friction reducing agent, a salt, and any combination thereof.

Suitable biocides include, but are not limited to, oxidizing and non-oxidizing biocides. Suitable non-oxidizing biocides include, for example, aldehydes (e.g., formaldehyde, glutaraldehyde, and acrolein), amine-type compounds (e.g., quaternary amine compounds and cocodiamine), halogenated compounds (e.g., 2 bromo-2 nitropropane-3-diol (Bronopol) and 2 2 dibromo-3-nitrilopropionamide (DBNPA)), and sulfur compounds (e.g., isothiazolone, carbamates, and metronidazole). Suitable oxidizing biocides include, for example, sodium hypochlorite, trichloroisocyanuric acids, dichloroisocyanuric acid, calcium hypochlorite, lithium hypochlorite, chlorinated hydantoins, stabilized sodium hypobromite, activated sodium bromide, brominated hydantoins, chlorine dioxide, ozone, and peroxides.

Suitable surfactants include, but are not limited to, anionic surfactants and nonionic surfactants. Anionic surfactants include, for example, alkyl aryl sulfonates, olefin sulfonates, paraffin sulfonates, alcohol sulfates, alcohol ether sulfates, alkyl carboxylates and alkyl ether carboxylates, alkyl and ethoxylated alkyl phosphate esters, and mono and dialkyl sulfosuccinates and sulfosuccinamates. Nonionic surfactants include, for example, alcohol alkoxylates, alkylphenol alkoxylates, block copolymers of ethylene, propylene and butylene oxides, alkyl dimethyl amine oxides, alkyl-bis (2 hydroxyethyl) amine oxides, alkyl amidopropyl dimethyl amine oxides, alkylamidopropyl-bis (2 hydroxyethyl) amine oxides, alkyl polyglucosides, polyalkoxylated glycerides, sorbitan esters and polyalkoxylated sorbitan esters, and alkoyl polyethylene glycol esters and diesters.

In some embodiments, the additional component is selected from the group consisting of a paraffin inhibitor, an emulsifier, a water clarifier, a dispersant, an emulsion breaker, a hydrogen sulfide scavenger, a gas hydrate inhibitor, a pH modifier, a synergistic compound, an asphaltene inhibitor, an antioxidant, a pour point depressant, a viscosity modifier, a flow back aid, a friction reducer, a crosslinking agent, a proppant, a nonionic surfactant, a cationic surfactant, an anionic surfactant, an amphoteric surfactant, an oxidizing agent, a water-soluble enzyme, a clay stabilizer, a buffer, and any combination thereof.

The amount of additional component in the composition is not particularly limited. For example, the composition may comprise from about 1 wt. % to about 50 wt. % of the additional component, such as from about 1 wt. % to about 45 wt. %, from about 1 wt. % to about 40 wt. %, from about 1 wt. % to about 35 wt. %, from about 1 wt. % to about 30 wt. %, from about 1 wt. % to about 25 wt. %, from about 1 wt. % to about 20 wt. %, from about 1 wt. % to about 15 wt. %, from about 1 wt. % to about 10 wt. %, from about 1 wt. % to about 5 wt. %, from about 5 wt. % to about 10 wt. %, from about 10 wt. % to about 20 wt. %, or from about 15 wt. % to about 30 wt. % of the additional component.

The present disclosure also provides methods of inhibiting corrosion, including UDC, comprising adding the compositions disclosed herein to a metal surface in contact with a medium. In some embodiments, the metal surface comprises a deposit and the method inhibits corrosion of the metal surface underneath the deposit. The composition(s) may be added, for example, intermittently, automatically, and/or manually to the metal surface. The composition(s) may be added to the metal surface in the absence of a medium and/or in the presence of a medium.

The medium may comprise, for example, a liquid, such as an aqueous fluid, a hydrocarbon liquid, a gas (e.g., H₂S, CO₂), or any combination thereof.

The medium may comprise, for example, about 0.1 wt. % to about 100 wt. % water, such as from about 1 wt. % to about 90 wt. %, about 5 wt. % to about 80 wt. %, or about 10 wt. % to about 70 wt. %.

The medium may comprise, for example, about 0 wt. % to about 99 wt. % hydrocarbon liquid, such as from about 1 wt. % to about 75 wt. %, about 1 wt. % to about 50 wt. %, about 1 wt. % to about 25 wt. %, or about 1 wt. % to about 10 wt. %.

The medium may comprise, for example, about 1 wt. % to about 99 wt. % gas, such as from about 1 wt. % to about 75 wt. %, about 1 wt. % to about 50 wt. %, about 1 wt. % to about 25 wt. %, or about 1 wt. % to about 10 wt. %.

In some embodiments, the medium is an aqueous medium, such as produced water, seawater, municipal water, “gray” water, brackish water, fresh water, recycled water, salt water, frac water, surface water, connate, groundwater, wastewater, or any combination of the foregoing. The aqueous medium may be a continuously flowing medium, such as produced water flowing from a subterranean reservoir and into or through a pipe or tank. The aqueous medium may also be, for example, wastewater isolated from a continuous manufacturing process flowing into a wastewater treatment apparatus. In other embodiments, the aqueous medium is a batch, or plug, substantially disposed in a batchwise or static state within a metal containment.

In some embodiments, the medium comprises cooling water, hot loop water, a glycol/water mixture, a brine, or any mixture thereof.

The methods disclosed herein may be carried out in, for example, a cooling water system that supplies water to one or more processes in which thermal energy from a comparatively hot process stream is transferred to a comparatively cool water stream via a divided heat exchange surface. In some implementations, the corrosion inhibitor compositions according to the disclosure can be used in an open circulating cooling water system, such as an open circulating cooling water system that includes one or more cooling towers that cool water via evaporative cooling.

The presently disclosed compositions are useful for inhibiting corrosion of metal surfaces in contact with any type of deposit or corrodent in the medium, such as metal cations, metal complexes, metal chelates, organometallic complexes, aluminum ions, ammonium ions, barium ions, chromium ions, cobalt ions, cuprous ions, cupric ions, calcium ions, ferrous ions, ferric ions, hydrogen ions, magnesium ions, manganese ions, molybdenum ions, nickel ions, potassium ions, sodium ions, strontium ions, titanium ions, uranium ions, vanadium ions, zinc ions, bromide ions, carbonate ions, chlorate ions, chloride ions, chlorite ions, dithionate ions, fluoride ions, hypochlorite ions, iodide ions, nitrate ions, nitrite ions, oxide ions, perchlorate ions, peroxide ions, phosphate ions, phosphite ions, sulfate ions, sulfide ions, sulfite ions, hydrogen carbonate ions, hydrogen phosphate ions, hydrogen phosphite ions, hydrogen sulfate ions, an acid, such as carbonic acid, hydrochloric acid, nitric acid, sulfuric acid, nitrous acid, sulfurous acid, a peroxy acid, or phosphoric acid, ammonia, bromine, carbon dioxide, chlorine, chlorine dioxide, fluorine, hydrogen chloride, hydrogen sulfide, iodine, nitrogen dioxide, nitrogen monoxide, oxygen, ozone, sodium sulfate, magnesium sulfate, hydrogen peroxide, polysaccharides, metal oxides, sands, clays, silicon dioxide, titanium dioxide, muds, insoluble inorganic and/or organic particulates, an oxidizing agent, a chelating agent, an alcohol, and any combination of the foregoing.

In some embodiments, the medium and/or deposit may include a corrodent selected from the group consisting of sand, iron sulfide, elemental sulfur, polysulfide, and any combination thereof.

The deposit may comprise any amount of each corrodent, such as from about 0 wt. % to about 100 wt. %, about 5 wt. % to about 90 wt. %, about 10 wt. % to about 70 wt. %, or about 25 wt. % to about 50 wt. % of any corrodent that may be present. For example, a deposit may comprise from about 25 wt. % to about 75 wt. % of elemental sulfur and from about 25 wt. % to about 75 wt. % iron sulfide.

Additionally, the medium may comprise any amount of each corrodent, such as from about 0 or 1 ppm to about 5,000 ppm, about 0 or 1 ppm to about 3,000 ppm, about 0 or 1 ppm to about 2,000 ppm, about 0 or 1 ppm to about 1,000 ppm, about 0 or 1 ppm to about 500 ppm, or about 0 or 1 ppm to about 50 ppm of any corrodent.

In some embodiments, the medium is an aqueous medium with a pH of about 1 to about 14. For example, the aqueous medium may have a pH of about 2 to about 14, about 3 to about 14, about 4 to about 14, about 5 to about 14, about 6 to about 14, about 7 to about 14, about 8 to about 14, about 9 to about 14, about 10 to about 14, about 1 to about 13, about 1 to about 12, about 1 to about 11, about 1 to about 10, about 1 to about 9, about 1 to about 8, about 1 to about 7, about 1 to about 6, about 1 to about 5, about 4 to about 12, about 5 to about 11, about 6 to about 10, or about 6 to about 8.

The presently disclosed compositions are useful for inhibiting corrosion of surfaces comprising a variety of different metals. In some embodiments, the metal surface comprises iron and/or steel, such as stainless steel, mild steel, and/or carbon steel.

In some embodiments, a pipe, such as a pipeline, a flowline, a downhole tubular, a casing, a tank, or a separator, or any component in fluid communication with the pipe comprises the metal surface. In some aspects, a pipe or a tank (e.g., railroad tank car or a tank truck/tanker) comprises the metal surface.

The composition (and/or optional additional component if separate from the composition) may be added to the metal surface dissolved in a solvent, partially dissolved in a solvent, and/or dispersed in a solvent. The addition may involve manual addition, automatic addition, dripping, pouring, spraying, pumping, injecting, or otherwise adding the composition and optional additional component to the metal surface. In some embodiments, the composition may be heated, such as from about 30° C. to about 100° C., prior to addition.

In some embodiments, the metal surface to be treated with the presently disclosed composition may be located in a cooling water system, a boiler water system, a petroleum well, a downhole formation, a geothermal well, a mineral washing process, a flotation and benefaction process, a papermaking process, a gas scrubber, an air washer, a continuous casting processes, an air conditioning and refrigeration process, a water reclamation process, a water purification process, a membrane filtration process, a clarifier, a municipal sewage treatment process, a municipal water treatment process, or a potable water system.

The amount of composition added to the metal surface may vary. For example, the composition may be added to the metal surface at a concentration of about 5 mL per m² of the metal surface to about 500 mL per m² of the metal surface, such as from about 10 mL per m² to about 500 mL per m², about 20 mL per m² to about 500 mL per m², about 30 mL per m² to about 500 mL per m², about 40 mL per m² to about 500 mL per m², about 50 mL per m² to about 500 mL per m², about 60 mL per m² to about 500 mL per m², about 70 mL per m² to about 500 mL per m², about 80 mL per m² to about 500 mL per m², about 90 mL per m² to about 500 mL per m², about 100 mL per m² to about 500 mL per m², about 150 mL per m² to about 500 mL per m², about 200 mL per m² to about 500 mL per m², about 250 mL per m² to about 500 mL per m², about 5 mL per m² to about 400 mL per m², about 5 mL per m² to about 300 mL per m², about 5 mL per m² to about 200 mL per m², about 5 mL per m² to about 100 ml per m², about 5 mL per m² to about 75 mL per m², about 5 mL per m² to about 50 mL per m², or about 5 mL per m² to about 25 mL per m² of the metal surface.

In accordance with the present disclosure, 1 mil film thickness equals about 28.3 mL composition per m² of metal surface, 3 mil film thickness equals about 84.9 mL composition per m² of metal surface, and 10 mil film thickness equals about 283 mL composition per m² of metal surface.

The methods disclosed herein may comprise forming a film with the composition on the metal surface, wherein the film has a thickness of about 1 mil to about 10 mils, such as from about 1 to about 9 mils, about 1 to about 7 mils, about 1 to about 5 mils, about 1 to about 3 mils, about 2 to about 10 mils, about 4 to about 10 mils, about 6 to about 10 mils, or about 8 to about 10 mils.

The foregoing may be better understood by reference to the following examples, which are intended for illustrative purposes and are not intended to limit the scope of the disclosure or its application in any way.

### EXAMPLES

Corrosion tests were conducted using a static autoclave (SA) apparatus. SA corrosion tests were conducted in Hastelloy C276 vessels with a volume capacity of 250 mL. The material used for the testing was AISI 1018 carbon steel machined to a flat custom-designed coupon (10.3 cm²) with 600 grit polished finish. A PEEK holder was used to secure the coupons and provided a smooth horizontal surface for the loose solid particles to remain motionless and in contact with the steel for the duration of the test. About 0.5 mL of the neat (undiluted) batch inhibitor was placed on the surface of the coupon and spread to ensure complete coverage. After about 5 minutes, the inhibited coupon was allowed to drip dry for one minute and excess solution was wiped from the holder. After inhibitor application, solid particles were introduced by placing 0.3 g total of sand, sulfur, iron sulfide, or a combination thereof onto the coupon surface with equal % weight of each solid. The thickness of the deposit was about 0.2 mm. Filmed coupons with solids were then introduced to the CO₂-purged brine. Then, about 50 ppm of sodium tetrasulfide was added to the brine for tests that had elemental sulfur present.

Once the autoclaves were sealed, the fluids were heated to a temperature of about 40° C., followed by the introduction of H₂S, CO₂ and N2 gases. The autoclaves were stirred at a rate of about 100 rpm, not to impart any appreciable amount of shear onto the metal surface but to minimize heat gradients forming in the test vessel when simulating a low flow regime. The testing conditions are provided in Table 1. At the end of the test period, the coupons were removed from the autoclaves. The coupons were cleaned with inhibited hydrochloric acid solution containing 1,3-dibutyl-2-thiourea and then rinsed thoroughly with de-ionized water and methanol. The coupons were then wiped with a tissue and oven dried (about 60° C.). The coupons were photographed and a ZEISS Stemi 508 microscope was used to examine and record the appearance of the metal surface at 10× magnification. A white-light interferometer (Bruker) was also employed in this study to quantify any pitting corrosion. General corrosion was determined by weight loss method. Also, the maximum pit depth was used to assess and compare corrosion inhibitors performance.

The batch inhibitor comprised about 5 wt. % to about 10 wt. % of trimer acid CAS No. 68937-90-6 and about 8 wt. % to about 20 wt. % of viscosifier dimer acid CAS No. 61788-89-4. The first reaction product of the batch inhibitor was prepared by reacting TOFA and TEPA, and the inhibitor comprised about 2 wt. % to about 15 wt. % of the first reaction product. The second reaction product of the batch inhibitor was prepared by reacting TOFA and TEPA, and the inhibitor comprised about 5 wt. % to about 20 wt. % of the second reaction product.

TABLE 1
Static autoclave test conditions

| SALT | g/L | PARAMETER | VALUE |
|---|---|---|---|
| NaCl | 73.7 | Temp (° C.) | 40 |
| MgCl₂•6H₂O | 10.9 | PCO₂ (psi) | 12 |
| CaCl₂•2H₂O | 36.7 | PH₂S (psi) | 2.4 |
| NaHCO₃ | 0.605 | Total pressure | 798 |
| | | (psi) | |
| SrCl₂•6H₂O | 2.95 | Coupons | AISI 1018 |
| Polysulfide | 0.050 | Duration for all | 6 days |
| | | UDC tests | |

When iron sulfide, elemental sulfur and/or sand were combined, a synergistic effect on the corrosion rate was observed. As shown in Table 2, there was an increase in both the general and localized corrosion rates. This result indicated that the development of a novel batch corrosion inhibitor was required to inhibit corrosion under the harsh conditions where under-deposit solids were present. The general corrosion rate with batch application of one of the novel and inventive corrosion inhibitor compositions disclosed herein was determined to be about 0.03 mm/y, with no evidence of pitting.

TABLE 2

| | Corrosion | Visual | Pitting Rate (mm/y) |
|---|---|---|---|
| Solids | rate (mm/y) | Observation | (Deepest Pit) WLI |
| No UD solids | 0.17 | General | 0 |
| | | corrosion | |
| UD solids | 4.70-5.21 | Pitting | 5.72-34.20 |
| Inhibitor | 0.03 | General | 0.00 |
| | | corrosion | |

All of the compositions and methods disclosed and claimed herein can be made and executed without undue experimentation in light of the present disclosure. While this invention may be embodied in many different forms, there are described in detail herein specific preferred embodiments of the invention. The present disclosure is an exemplification of the principles of the invention and is not intended to limit the invention to the particular embodiments illustrated. In addition, unless expressly stated to the contrary, use of the term “a” is intended to include “at least one” or “one or more.” For example, “a solvent” is intended to include “at least one solvent” or “one or more solvents.”

Any ranges given either in absolute terms or in approximate terms are intended to encompass both, and any definitions used herein are intended to be clarifying and not limiting. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges (including all fractional and whole values) subsumed therein.

Any composition disclosed herein may comprise, consist of, or consist essentially of any element, component and/or ingredient disclosed herein or any combination of two or more of the elements, components or ingredients disclosed herein.

Any method disclosed herein may comprise, consist of, or consist essentially of any method step disclosed herein or any combination of two or more of the method steps disclosed herein.

The transitional phrase “comprising,” which is synonymous with “including,” “containing,” or “characterized by,” is inclusive or open-ended and does not exclude additional, un-recited elements, components, ingredients and/or method steps.

The transitional phrase “consisting of” excludes any element, component, ingredient, and/or method step not specified in the claim.

The transitional phrase “consisting essentially of” limits the scope of a claim to the specified elements, components, ingredients and/or steps, as well as those that do not materially affect the basic and novel characteristic(s) of the claimed invention.

Unless specified otherwise, all molecular weights referred to herein are weight average molecular weights and all viscosities were measured at 25° C. with neat (not diluted) polymers.

As used herein, the term “about” refers to the cited value being within the errors arising from the standard deviation found in their respective testing measurements, and if those errors cannot be determined, then “about” may refer to, for example, within 5%, 4%, 3%, 2%, or 1% of the cited value.

Furthermore, the invention encompasses any and all possible combinations of some or all of the various embodiments described herein. It should also be understood that various changes and modifications to the presently preferred embodiments described herein will be apparent to those skilled in the art. Such changes and modifications can be made without departing from the spirit and scope of the invention and without diminishing its intended advantages. It is therefore intended that such changes and modifications be covered by the appended claims.

What is claimed is:

1. A method of inhibiting corrosion of a metal surface in contact with a medium, comprising:
adding a composition to the metal surface, wherein the composition comprises a first reaction product, a second reaction product, a trimer acid, a solvent, and a viscosifier dimer acid, wherein the first reaction product is produced by reacting a first amine with a first carboxylic acid and a dimer acid, and the second reaction product is produced by reacting a second amine with a second carboxylic acid.

2. The method of claim 1, wherein the metal surface comprises a deposit and the method inhibits corrosion underneath the deposit.

3. The method of claim 2, wherein the deposit and/or the medium comprises a member selected from the group consisting of iron sulfide, elemental sulfur, sand, polysulfide, and any combination thereof.

4. The method of claim 1, wherein the first carboxylic acid and the second carboxylic acid are independently selected from a fatty acid.

5. The method of claim 1, wherein the first carboxylic acid and the second carboxylic acid are independently selected from the group consisting of tall oil fatty acid, a C₁₆ fatty acid, a C₁₇ fatty acid, a C₁₈ fatty acid, and any combination thereof.

6. The method of claim 1, wherein the first amine and the second amine are independently selected from the group consisting of tetraethylene pentamine (TEPA), triethylene tetramine (TETA), pentaethylene hexamine (PEHA), hexaethylene heptamine (HEHA), and any combination thereof.

7. The method of claim 1, wherein the dimer acid is selected from the group consisting of a C₁₀-C₄₀ fatty acid and/or wherein the trimer acid is selected from the group consisting of a C₁₀-C₂₀ fatty acid.

8. The method of claim 1, wherein the solvent is selected from the group consisting of heavy reformate, light aromatic naphtha, xylene, toluene, and any combination thereof.

9. The method of claim 1, wherein the viscosifier dimer acid comprises 9-[(Z)-non-3-enyl]-10-octylnonadecanedioic acid.

10. The method of claim 1, wherein the composition comprises from about 5 wt. % to about 25 wt. % of the first reaction product, from about 5 wt. % to about 25 wt. % of the second reaction product, from about 5 wt. % to about 15 wt. % of the trimer acid, from about 20 wt. % to about 80 wt. % of the solvent, and/or from about 5 wt. % to about 25 wt. % of the viscosifier dimer acid.

11. The method of claim 1, wherein the first reaction product comprises a cyclic amine and/or wherein the second reaction product comprises an amide-containing compound.

12. The method of claim 1, wherein the composition is added to the metal surface at a concentration of about 5 mL per m² of the metallic surface to about 500 mL per m² of the metallic surface.

13. The method of claim 1, further comprising adding the composition to the metal surface in the presence or in the absence of the medium.

14. The method of claim 1, further comprising adding the composition intermittently to the metal surface.

15. The method of claim 1, wherein the composition comprises a ratio of the viscosifier dimer acid to the trimer acid of greater than 1:1 to about 100:1.

16. A composition, comprising:
a first reaction product,
a second reaction product,
a trimer acid,
a solvent, and
a viscosifier dimer acid, wherein the first reaction product is produced by reacting a first amine with a first carboxylic acid and a dimer acid, and the second reaction product is produced by reacting a second amine with a second carboxylic acid.

17. The composition of claim 16, wherein the first carboxylic acid and the second carboxylic acid are independently selected from a fatty acid.

18. The composition of claim 16, wherein the first amine and the second amine are independently selected from the group consisting of TEPA, TETA, PEHA, HEHA, and any combination thereof.

19. The composition of claim 16, wherein the dimer acid is selected from the group consisting of a C₁₀-C₄₀ fatty acid, wherein the trimer acid is selected from the group consisting of a C₁₀-C₂₀ fatty acid, wherein the solvent is selected from the group consisting of heavy reformate, light aromatic naphtha, xylene, toluene, and any combination thereof, wherein the viscosifier dimer acid comprises 9-[(Z)-non-3-enyl]-10-octylnonadecanedioic acid, wherein the first reaction product comprises a cyclic amine, and/or wherein the second reaction product comprises an amide-containing compound.

20. The composition of claim 16, wherein the composition comprises a ratio of the viscosifier dimer acid to the trimer acid of greater than 1:1 to about 100:1.
